(19) United States
(12) Patent Application Publication
(10) Pub. No.: US 2023/0262495 A1
(43) Pub. Date: Aug. 17, 2023

(54) SERVER APPARATUS, SENSOR APPARATUS, VISUALIZATION SYSTEM, MONITORING METHOD, COLLECTION METHOD, AND NON-TRANSITORY COMPUTER READABLE MEDIUM

(71) Applicant: NEC CORPORATION, Minato-ku, Tokyo (JP)

(72) Inventor: Takamichi INOUE, Tokyo (JP)

(73) Assignee: NEC Corporation, Minato-ku, Tokyo (JP)

(21) Appl. No.: 18/012,348

(22) PCT Filed: Jun. 30, 2021
(86) PCT No.: PCT/JP2021/024874

§ 371 Date: Dec. 22, 2022

(30) Foreign Application Priority Data
Jul. 1, 2020 (JP) 2020-114078

(51) Int. Cl. H04W 24/08; H04B 17/318

(52) U.S. Cl. CPC H04W 24/08; H04B 17/318

(57) ABSTRACT

An object is to provide a server apparatus that can specify an access point to be monitored when a frequency channel used by the access point cannot be specified. In a first example aspect of the present disclosure, a server apparatus (10) includes a management unit (11) configured to manage a list showing a first access point that can no longer be monitored among a plurality of access points to be monitored, a communication unit (12) configured to transmit a collection condition indicating frequency channels available to the first access point to a sensor apparatus and receiving monitoring data generated by the sensor apparatus from packets collected according to the collection condition, and a monitoring unit (13) configured to resume monitoring of the first access point when the monitoring data includes information specifying the first access point.

### TECHNICAL FIELD

The present disclosure relates to a server apparatus, a sensor apparatus, a visualization system, a monitoring method, and a program.

### BACKGROUND ART

In recent years, a cloud server has maintained or improved the quality of a wireless communication system by managing communication quality within the system.

The cloud server monitors wireless communication terminals, base stations, or access points in the wireless communication system.

Patent Literature 1 discloses a process of measuring a radio environment related to communication using a frequency channel to be measured and transmitting a result of the measurement to a control apparatus by using a frequency channel different from the frequency channel to be measured.

### CITATION LIST

### Patent Literature

Patent Literature 1: Japanese Unexamined Patent Application Publication No. 2020-005009

### SUMMARY OF INVENTION

### Technical Problem

An access point performing wireless LAN communication may change a frequency channel used for wireless LAN communication by performing frequency channel auto setting, DFS (Dynamic Frequency Selection) function, or the like. Here, in the process for measuring the radio environment disclosed in Patent Literature 1, there is a problem that if a frequency channel of an access point is changed, the frequency channel used by the access point cannot be specified, and thus the radio environment cannot be measured.

An object of the present disclosure is to provide a server apparatus, a sensor apparatus, a visualization system, a monitoring method, and a program that can specify an access point to be monitored when a frequency channel used by the access point cannot be specified.

### Solution to Problem

In a first example aspect of the present disclosure, a server apparatus includes: a management unit configured to manage a list showing a first access point that can no longer be monitored among a plurality of access points to be monitored; a communication unit configured to transmit a collection condition indicating frequency channels available to the first access point to a sensor apparatus and receiving monitoring data generated by the sensor apparatus from packets collected according to the collection condition; and a monitoring unit configured to resume monitoring of the first access point when the monitoring data includes information specifying the first access point.

In a second example aspect of the present disclosure, a sensor apparatus includes: a communication unit configured to receive a collection condition indicating a frequency channel from a server apparatus; a collection unit configured to collect packets transmitted from an access point according to the collection condition; and an extraction unit configured to generate monitoring data that the server apparatus is to be notified of from the collected packets. The communication unit transmits the monitoring data to the server apparatus.

In a third example aspect of the present disclosure, a visualization system includes: a sensor apparatus configured to collect packets transmitted from an access point according to a collection condition indicating a frequency channel; and a server apparatus configured to manage a list indicating a first access point that can no longer be monitored among a plurality of access points to be monitored, transmit a collection condition indicating frequency channels available to the first access point to the sensor apparatus, receive monitoring data generated by the sensor apparatus from the packets collected according to the collection condition, and resume monitoring the first access point when the monitoring data includes information specifying the first access point.

In a fourth example aspect of the present disclosure, a monitoring method executed by a server apparatus includes: managing a list showing a first access point that can no longer be monitored among a plurality of access points to be monitored; transmitting a collection condition indicating frequency channels available to the first access point to a sensor apparatus and receiving monitoring data generated by the sensor apparatus from packets collected according to the collection condition; and resuming monitoring of the first access point when the monitoring data includes information specifying the first access point.

In a fifth example aspect of the present disclosure, a collection method executed by a sensor apparatus includes: receiving a collection condition indicating a frequency channel from a server apparatus; collecting packets transmitted from an access point according to the collection condition; and generating monitoring data that the server apparatus is to be notified of from the collected packets. The monitoring data is transmitted to the server apparatus.

In a sixth example aspect of the present disclosure, a program causes a computer to execute: managing a list showing a first access point that can no longer be monitored among a plurality of access points to be monitored; transmitting a collection condition indicating frequency channels available to the first access point to a sensor apparatus and receiving monitoring data generated by the sensor apparatus from packets collected according to the collection condition; and resuming monitoring of the first access point when the monitoring data includes information specifying the first access point.

### Advantageous Effects of Invention

According to the present disclosure, it is possible to provide a server apparatus, a sensor apparatus, a visualization system, a monitoring method, and a program that can specify an access point to be monitored when a frequency channel used by the access point cannot be specified.

### BRIEF DESCRIPTION OF DRAWINGS

FIG. 1 shows a configuration of a server apparatus according to a first example embodiment;

FIG. 2 shows a configuration of a visualization system according to a second example embodiment;

FIG. 3 shows a configuration of a wireless sensor according to the second example embodiment;

FIG. 4 shows a configuration of a cloud server according to the second example embodiment;

FIG. 5 shows a flow of processing for transmitting monitoring data in a wireless sensor according to the second example embodiment;

FIG. 6 shows a flow of processing for generation a list in the cloud server according to the second example embodiment;

FIG. 7 shows a flow of processing for search missing APs in the cloud server according to the second example embodiment; and

FIG. 8 shows configurations of the sensor apparatus, the wireless sensor, and the cloud server according to each example embodiment.

### EXAMPLE EMBODIMENT

### First Example Embodiment

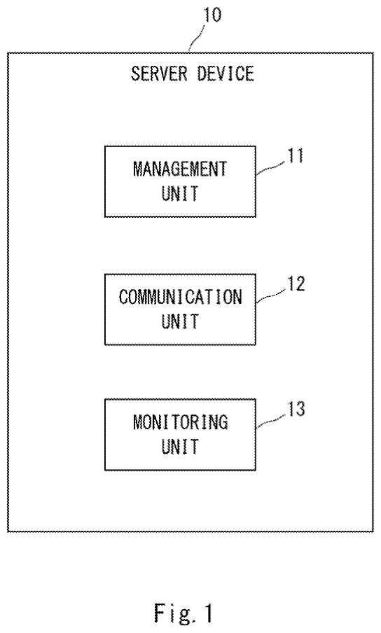

Example embodiments of the present disclosure will be described below with reference to the drawings. A configuration example of a server apparatus 10 according to a first example embodiment will be explained with reference to FIG. 1. The server apparatus 10 may be a computer apparatus operated by a processor executing a program stored in a memory.

The server apparatus 10 has a management unit 11, a communication unit 12, and a monitoring unit 13. Components of the server apparatus 10, such as the management unit 11, the communication unit 12, and the monitoring unit 13, may be software or modules in which processing is executed by a processor executing a program stored in a memory. Alternatively, components of the server apparatus 10 may be hardware, such as a circuit or chip.

The management unit 11 manages a list showing access points that can no longer be monitored from among a plurality of access points to be monitored. The access point may be referred to as a master unit in wireless LAN communications. A wireless communication terminal that performs wireless LAN communication with the access point may be referred to as a slave unit.

The access point that can no longer be monitored may be, for example, an access point that has changed its frequency channel by performing frequency channel auto setting, DFS function, or the like. Alternatively, the access point that can no longer be monitored may be an access point where a failure such as stall has occurred. An access point where stall or other failure has occurred becomes unresponsive, such as being unable to emit radio waves to transmit signals.

The list shows, for example, names that enable identification of the access points or address information about the access points. The list may be referred to as a database. The list may be saved, stored, or recorded, for example, in a memory in the server apparatus 10. The management unit 11 may update the list when there is a change in the contents of the list. For example, if an access point that can no longer be monitored is generated, the management unit 11 may add the access point to the list and remove the access point that can now be monitored from the list.

Alternatively, it may be possible to specify access points that can no longer be monitored by showing only those access points that can be monitored from among the plurality of access points to be monitored.

The communication unit 12 transmits to the sensor apparatus a collection condition indicating frequency channels available to the access point that can no longer be monitored. The frequency channel has a specific frequency range and a defined center frequency. The available frequency channel may be defined in the specification of the access point. Information about the available frequency channel at each access point to be monitored may be saved in advance in the server apparatus 10. For example, an administrator or the like of the server apparatus 10 may input information about the available frequency channel for each access point. Alternatively, the server apparatus 10 may obtain information about the available frequency channel for each access point from other server apparatus or the like via a network.

The collection condition may be referred to as a packet capture condition. The sensor apparatus collects or captures packets transmitted from or to the access point according to the collection condition. In addition to the frequency channel, the collection condition may include at least one of a frequency band, a collection time, a collection period, and the number of bytes.

In addition, the sensor apparatus extracts information from the collected packets and generates monitoring data. For example, the monitoring data generated by the sensor apparatus from the packets may be address information such as a transmission destination address or a transmission source address of the packet. The address information may be, for example, information indicating an access point. Alternatively, the information extracted from the packets by the sensor apparatus may be RSSI (Received Signal Strength Indicator), a bandwidth occupancy, the number of packets transmitted by the access point during a predetermined period of time, a throughput, a retransmission rate, etc.

A packet may be referred to as a transmission frame or data, or the like. The packet may be user data such as image data or video data, or it may be control data. The user data may be referred to as a data frame, for example, and the control data may be referred to as a management frame or a control frame.

The communication unit 12 receives the monitoring data generated in the sensor apparatus. The communication unit 12 may, for example, receive the monitoring data via a mobile network provided by a telecommunications carrier.

When the monitoring data includes information specifying the access point that can no longer be monitored, the monitoring unit 13 resumes monitoring the access point that can no longer be monitored.

A situation in which an access point can no longer be monitored occurs, for example, when a change in the frequency channel of the access point prevents the sensor apparatus from collecting packets transmitted from the access point. Therefore, if the sensor apparatus can collect packets from the access point that can no longer be monitored, the monitoring unit 13 determines or recognizes that the access point can be monitored.

When the monitoring unit 13 resumes monitoring, it may mean, for example, displaying the access point on a display apparatus used integrally with the server apparatus 10 and making the access point visible to the administrator or the like of the server apparatus 10. Alternatively, the monitoring unit 13 may transmit information identifying the access point to another monitoring apparatus or the like and cause a display apparatus used integrally with the other monitoring apparatus to display the access point.

As described above, when the server apparatus 10 can no longer monitor the access point, it notifies the sensor apparatus that collects packets of information about the frequency channels available to the access point. This allows the sensor apparatus to search or discover the access point that can no longer be monitored by collecting packets transmitted on several frequency channels. As a result, the administrator or the like who manages the server apparatus 10 can monitor the access point that can no longer be monitored again.

### Second Example Embodiment

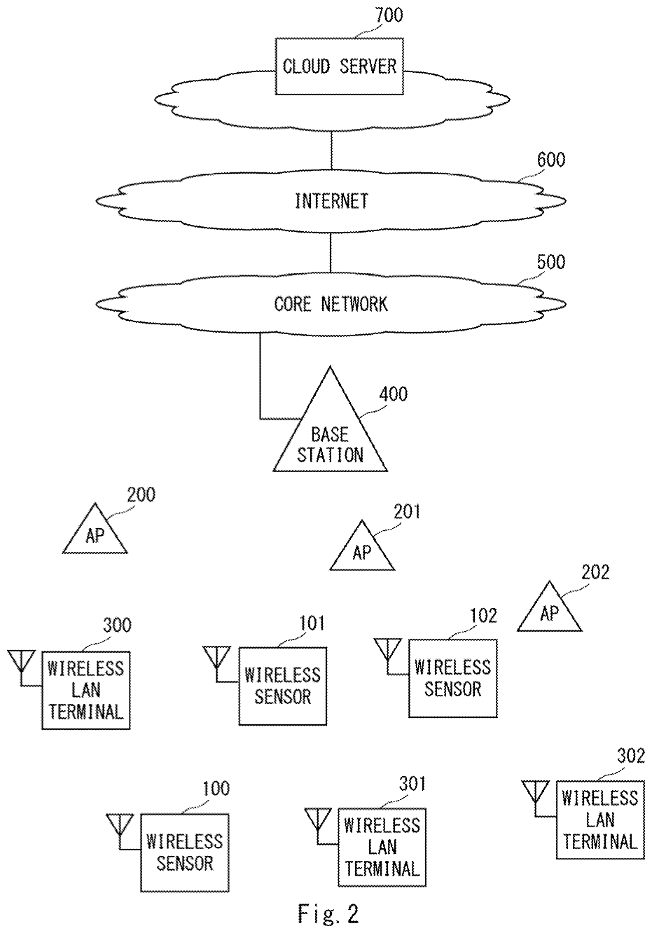

Next, an example of a configuration of a visualization system according to a second example embodiment will be explained with reference to FIG. 2. The visualization system monitors an AP (Access Point) 200 or the like by using information obtained by a cloud server 700 from a plurality of wireless sensors 100 to 102, and visualizes a quality status and the like of a wireless communication area formed by the AP 200.

The visualization system of FIG. 2 includes a base station 400, a core network 500, the Internet 600, and the cloud server 700. The visualization system in FIG. 2 also has wireless sensors 100 to 102, APs 200 to 202, and wireless LAN terminals 300 to 302. Each of the wireless sensors 100 to 102 corresponds to a sensor apparatus. The cloud server 700 corresponds to the server apparatus 10.

The base station 400 and the core network 500 correspond to a mobile network provided by a telecommunications carrier.

Each of the wireless LAN terminals 300 to 302, as slave units in wireless LAN communication, are connected to one of the APs 200 to 202, which are master units, and performs wireless LAN communication.

The wireless sensors 100 to 102 capture packets transmitted and received between the wireless LAN terminals 300 to 302 and the APs 200 to 202.

The wireless sensors 100 to 102 perform two-way communication with the cloud server 700 via the base station 400, the core network 500, and the Internet 600. The base station 400 may support, for example, LTE, 5G, or local 5G as a wireless communication standard. The base station 400 sets up an LTE line, a 5G line, or a local 5G line with the wireless sensors 100 to 102 or a wireless terminal to perform data communication. The wireless sensors 100 to 102 may also communicate with the Internet 600 via a wired line or Ethernet (registered trademark). In addition, the cloud server 700 may be disposed in an intranet that is constructed within a specific company or the like.

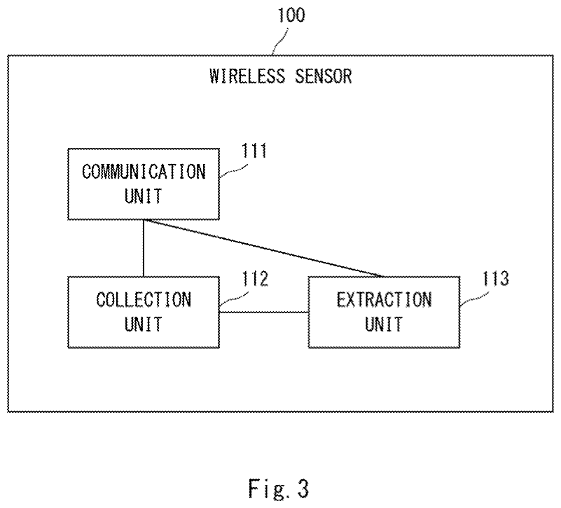

Next, a configuration example of the wireless sensor 100 according to the second example embodiment will be described with reference to FIG. 3. Further, since the wireless sensor 101 and the wireless sensor 102 have the same configuration as the wireless sensor 100, a detailed description of the wireless sensors 101 and 102 is omitted.

The wireless sensor 100 has a communication unit 111, a collection unit 112, and an extraction unit 113. The communication unit 111, the collection unit 112, and the extraction unit 113 may be software or modules in which processing is executed by a processor executing a program stored in a memory. Alternatively, the communication unit 111, the collection unit 112, and the extraction unit 113 may be hardware such as a circuit or chip.

The communication unit 111 communicates with the base station 400. The communication unit 111 communicates with the base station 400 by using, for example, the radio communication standard defined in 3GPP. Specifically, the communication unit 111 may communicate with the base station 400 by using LTE. The communication unit 111 may be composed of an antenna, a modulator, and a demodulator corresponding to a frequency of radio communication with the base station 400.

The communication unit 111 obtains packet collection condition and extraction condition from the cloud server 700 via the base station 400, the core network 500, and the Internet 600. The packet collection condition may be referred to as a packet capture condition. The communication unit 111 outputs the collection condition to the collection unit 112 and the extraction condition to the extraction unit 113. The communication unit 111 may periodically receive the collection condition and extraction condition from the cloud server 700, or may irregularly receive the changed collection condition and extraction condition. The collection and extraction conditions are set in the cloud server 700.

The collection unit 112 captures packets transmitted and received between the wireless LAN terminals 300 to 302 and the APs 200 to 202 according to the collection condition. The collection condition includes frequency channels. The collection unit 112 captures the packets being transmitted through the frequency channel included in the collection condition. In addition to the frequency channel, the collection condition may include a frequency band, a collection time, a collection period, the number of bytes, etc.

The collection unit 112 may be composed of an antenna, a modulator, and a demodulator corresponding to the frequency of wireless LAN communication with at least one of the APs 200 to 202.

If two frequency channels are set as the collection condition, the collection unit 112 may capture packets of different frequency channels simultaneously by using two each of antennas, modulators and demodulators. Alternatively, if two frequency channels are set as the collection condition, the collection unit 112 may use one each of antenna, modulator, and demodulator to switch frequency channels at predetermined intervals to capture packets of different frequency channels.

The extraction unit 113 extracts packets from the packets captured by the collection unit 112 according to the extraction condition. Extracting packets may be rephrased as selecting packets. The extraction condition may be, for example, a transmission destination BSSID (Basic Service Set Identifier) or a transmission source BSSID of the packet. The MAC (Media Access Control) address of the AP 200, for example, may be set in the BSSID. The extraction condition may also be a transmission destination IP address or a transmission source IP address of the packet. The extraction condition may also be a transmission destination MAC address or a transmission source MAC address of the packet. That is, the extraction unit 113 may extract packets transmitted from a specific wireless LAN terminal, for example, a wireless LAN terminal 300, from the captured packets. Alternatively, the extraction unit 113 may extract all packets transmitted to the AP 200 in the wireless LAN system 210. The extraction unit 113 may specify the addresses of a plurality of wireless LAN terminals as the extraction condition. In addition, the extraction condition may specify an IP address or a MAC address of the packet to be captured or an IP address or MAC address of the packet not to be captured.

The extraction unit 113 generates monitoring data to be observed or measured from the extracted packets. The category, kind, and the like of the monitoring data to be generated, may be specified in the extraction condition. For example, the extraction unit 113 may generate address information indicating a transmission source address or a transmission destination address set in a header of the extracted packet. Alternatively, the extraction unit 113 may generate RSSI data to be observed from the extracted packets. The RSSI is not the RSSI of the packet received by the wireless LAN terminal or AP, and instead is the RSSI of the packet received by the wireless sensor 100.

Furthermore, the extraction unit 113 may generate throughput data and transmission rate data of the packets transmitted by the wireless LAN terminals 300 to 302 by using the number of packets, the data length of the packets, and the like transmitted from the wireless LAN terminals 300 to 302 within a predetermined period of time. Moreover, the extraction unit 113 may specify whether the packet is a retransmitted packet by analyzing the header part of the packet and generate data indicating the number of retransmitted packets. The extraction unit 113 may also generate data about the bandwidth occupancy of the wireless LAN terminal 300 by using a maximum line speed between the AP and the wireless LAN terminal and throughput data of the wireless LAN terminal 300. The extraction unit 113 may also generate data about the retransmission rate of packets by using the total number of received packets and the number of retransmitted packets. The packet retransmission rate may be generated for each wireless LAN terminal or as data for all wireless LAN terminals.

The communication unit 111 transmits information such as RSSI generated in the extraction unit 113 to the cloud server 700 via the base station 400, the core network 500, and the Internet 600 as the monitoring data.

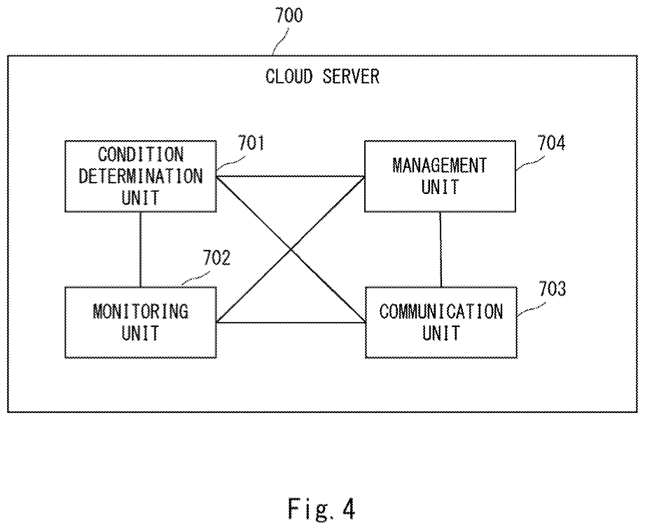

Next, a configuration example of the cloud server 700 will be described with reference to FIG. 4. The cloud server 700 may be a computer apparatus operated by a processor executing a program stored in a memory. The cloud server 700 may have a built-in memory for storing a database, and may be connected to the database server apparatus via a network, a cable, or the like. The cloud server 700 saves data received from the wireless sensors 100 to 102 in the database.

The cloud server 700 has a condition determination unit 701, a monitoring unit 702, a communication unit 703, and a management unit 704. The condition determination unit 701, the monitoring unit 702, the communication unit 703, and the management unit 704 may be software or modules in which processing is executed by a processor executing a program stored in a memory. Alternatively, the condition determination unit 701, the monitoring unit 702, the communication unit 703 and the management unit 704 may be hardware such as a circuit or a chip.

The monitoring unit 702 corresponds to the monitoring unit 13 of the server apparatus 10. The management unit 704 corresponds to the management unit 11 of the server apparatus 10. The communication unit 703 corresponds to the communication unit 12 of the server apparatus 10. Hereinafter, the functions or operations of the cloud server 700 different from those of the server apparatus 10 will be mainly described, and the functions or operations of the cloud server 700 similar to those of the server apparatus 10 will not be described in detail.

The condition determination unit 701 causes the monitoring unit 702 to display information about the setting of the collection condition and extraction condition. An administrator of the cloud server 700 may confirm the information displayed on the monitoring unit 702 and input the collection condition and extraction condition. The monitoring unit 702 may display, for example, parameter information, threshold information, and the like which can be selected as the collection condition and the extraction condition.

The condition determination unit 701 saves the collection condition and extraction condition determined according to the input information to the management unit 704 via the communication unit 703. The communication unit 703 also transmits the collection condition and extraction condition output from the condition determination unit 701 to at least one of the wireless sensors 100 to 102 via the Internet 600, the core network 500, and the base station 400. The condition determination unit 701 may determine different collection or extraction condition for each wireless sensor.

When the collection condition or the extraction condition is changed, the condition determination unit 701 may transmit a change notification indicating that the collection condition or the extraction condition has been changed to each wireless sensor. In this case, the wireless sensor that has received the change notification accesses the cloud server 700 to obtain the changed collection or extraction condition. Alternatively, the condition determination unit 701 may transmit the changed information to the wireless sensor without transmitting the change notification. Further alternatively, the condition determination unit 701 may periodically transmit the collection or extraction condition to each of the wireless sensors. The condition determination unit 701 also outputs the changed collection or extraction condition to the management unit 704 via the communication unit 703. The management unit 704 stores the received and changed collection or extraction condition.

The communication unit 703 receives the monitoring data from the wireless sensors 100 to 102. The communication unit 703 saves the received monitoring data in the management unit 704. The monitoring unit 702 processes the data saved in the management unit 704 into display data and displays the display data.

The management unit 704 holds information about a list of APs to be monitored. The list of APs to be monitored is identification information about all APs monitored in the visualization system. The identification information about the APs may be name or address information to identify the APs. In addition, the management unit 704 also saves a list of APs that can no longer be monitored. The list shows APs included in the APs to be monitored. The APs listed may be referred to as missing APs.

The monitoring unit 702 monitors APs that are shown in the list of APs to be monitored but are not shown in the list of APs that can no longer be monitored. The monitoring may be, for example, causing a display apparatus used integrally with the cloud server 700 to display the states of the APs. The state of the AP may be, for example, the frequency channel used by the AP, or information indicating whether a failure is occurring in the AP.

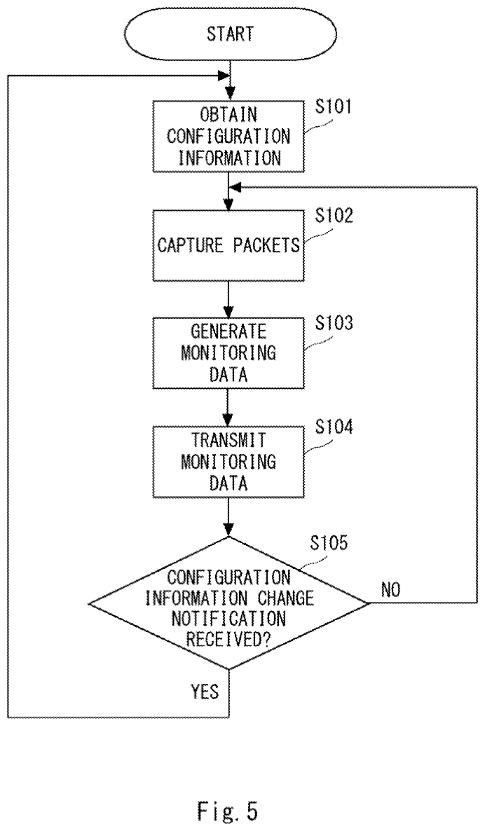

Next, a flow of processing for transmitting monitoring data in the wireless sensor 100 according to the second example embodiment is explained with reference to FIG. 5. First, the communication unit 111 receives configuration information from the cloud server 700 (S101). The configuration information includes at least one of the collection condition and the extraction condition. For example, the communication unit 111 may receive newly set collection condition and extraction condition or may receive a changed collection or extraction condition.

Next, the collection unit 112 captures the packets according to the collection condition (S102). For example, the collection unit 112 captures packets being transmitted via the frequency channel included in the collection condition. Next, the extraction unit 113 generates the monitoring data observed from the extracted packets according to the extraction condition (S103). The extraction unit 113 generates, for example, RSSI data as the monitoring data.

Next, the communication unit 111 transmits the monitoring data generated in the extraction unit 113 to the cloud server 700 (S104).

Next, the communication unit 111 determines whether or not the change notification of the configuration information has been received from the cloud server 700 (S105). When the communication unit 111 receives the change notification about the configuration information, the processing from Step S101 onward is repeated. If the communication unit 111 has not received the change notification about the configuration information, the processing from Step S102 onward is repeated.

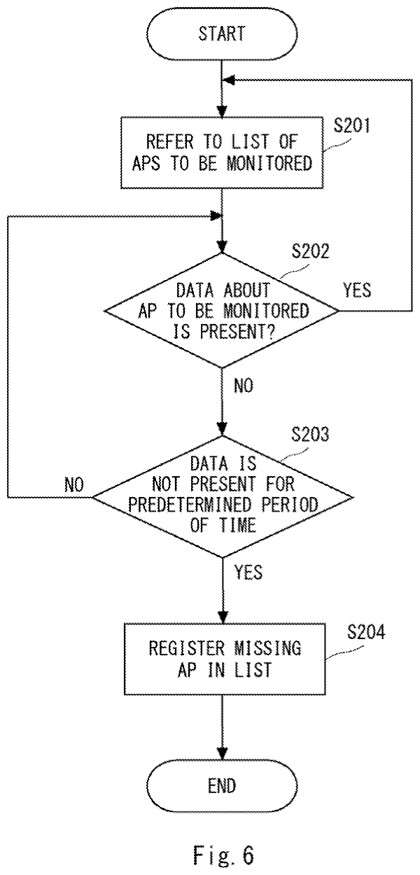

Next, a flow of processing for generation a list in the cloud server 700 according to the second example embodiment is explained with reference to FIG. 6. First, the management unit 704 refers to the list of APs to be monitored (S201). It is assumed that the APs to be monitored are, for example, predetermined. For example, the cloud server 700 may save in the management unit 704 information for identifying the APs to be monitored input by the administrator or the like.

Next, the management unit 704 determines whether or not data about each AP to be monitored is present (S202). The data about the APs may be, for example, the monitoring data about the AP received from the wireless LAN terminals 300 to 302. For example, the data about the AP 200 may be data whose transmission destination or source address indicates the AP 200, RSSI observed from a packet addressed for the AP 200 or transmitted from the AP 200, or the like. In other words, the presence of data about the AP 200 indicates that the monitoring unit 702 can monitor the AP 200. In other words, for example, if there is no data about the AP 200, the monitoring unit 702 indicates that the AP 200 cannot be monitored. The presence of data about the AP may mean the presence of monitoring data about the AP received from the wireless sensors 100 to 102 from a reference timing onward. The reference timing may be predetermined. The reference timing may be defined, for example, A second or B minutes before the current time (A and B are positive integers).

When the management unit 704 determines in Step S202 that data about all APs to be monitored is present, it repeats the processing from Step S201 onward. When the management unit 704 determines that data about at least one of the APs to be monitored is not present, it executes the processing of Step S203.

If, for example, the management unit 704 determines that data about the AP 200 is not present, it determines whether or not data about the AP 200 is not present for a predetermined period of time (S203). For example, the management unit 704 may determine whether or not data about the AP 200 is not present for a predetermined period of time from the reference timing. Alternatively, the management unit 704 may determine whether or not the number of times it is determined in Step S202 that no data about the AP 200 is present has reached a threshold. For example, when the threshold is three, if it is determined in Step S202 that no data about the AP 200 is present for the first time, the management unit 704 repeats the processing of Step S202, because the threshold has not been reached yet in Step S203. Here, even if the management unit 704 again determines in Step S202 that no data about the AP 200 is present, in Step S203, the management unit repeats the processing of Step S202, because the threshold has not been reached yet. When it is determined again in Step S202 that no data about the AP 200 is present, the management unit 704 executes the processing of Step S204, because the number of times the data related the AP 200 is determined not to be present has reached the threshold of three.

When it is determined in Step S203 that no data is present for a predetermined period of time, the management unit 704 registers the AP for which no data is present for the predetermined period of time as a missing AP in the list (S204).

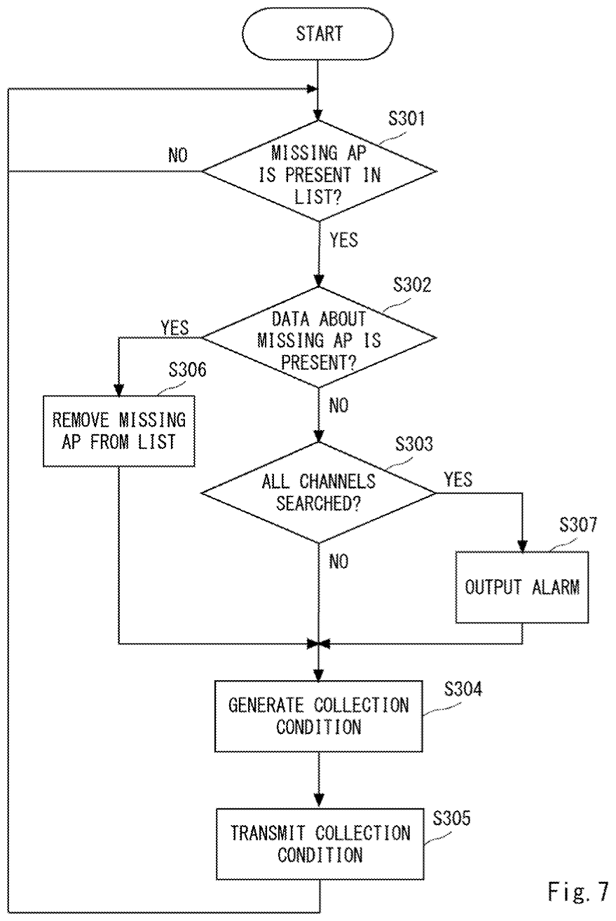

Next, a flow of the processing for generating the collection condition according to the second example embodiment is explained with reference to FIG. 7. First, the management unit 704 determines whether or not there is a missing AP in the list (S301). When the management unit 704 determines that a missing AP is present in the list, it determines whether or not data about the missing AP is present (S302). The data about the missing AP may be, for example, the monitoring data about the missing AP. If the management unit 704 determines that no data about the missing AP is present, the condition determination unit 701 determines whether or not all frequency channels available to the missing AP have been searched (S303). For example, the condition determination unit 701 determines whether there is a frequency channel that the wireless sensors 100 to 102 have not been notified of as the collection condition among the frequency channels available to the missing AP.

When all frequency channels available to the missing AP have not been searched, the condition determination unit 701 generates the collection condition including the frequency channels that have not been searched (S304). The fact that all frequency channels available to the missing AP have not been searched means that there are frequency channels available to the missing AP which the wireless sensors 100 to 102 have not been notified of. Therefore, the condition determination unit 701 generates the collection condition that includes the frequency channels which the wireless sensors 100 to 102 have not been notified of.

Next, the communication unit 703 transmits the generated collection condition to the wireless sensors 100 to 102 (S305). After the communication unit 703 generates the collection condition, the processing from Step S301 onward is repeated.

In Step S301, when the management unit 704 determines that no missing AP is present in the list, the management unit 704 repeatedly performs the processing of Step S301.

When the management unit 704 determines in Step S302 that the data of the missing AP is present, it deletes the missing AP with the relevant data from the list (S306). When the missing AP is removed from the list in the management unit 704, the condition determination unit 701 generates the collection condition including, for example, the frequency channel currently used by the missing AP (S304).

In Step S303, when the condition determination unit 701 determines that all frequency channels have been searched for the missing AP, the monitoring unit 702 outputs an alarm (S307). Having searched all frequency channels available to the missing AP means that even when the packets to be transmitted on all frequency channels available to the missing AP are captured, no packet whose transmission source or destination is the missing AP has been captured. In this case, it is highly possible that the missing AP has not changed its frequency channel due to DFS or the like, and instead a failure or the like has occurred, and thus data cannot be transmitted and received. Therefore, the monitoring unit 702 outputs an alarm to notify that a failure has occurred in the missing AP registered in the list.

As described above, for APs that can no longer be monitored, the visualization system according to the second example embodiment transmits the collection condition including the frequency channels available to the APs to the wireless sensors 100 to 102. This allows the wireless sensors 100 to 102 to capture packets with the AP as the transmission source or transmission destination even if the AP has changed its frequency channel. When the cloud server 700 receives the monitoring data about a missing AP, it can specify the presence of the missing AP and thus resumes monitoring of the missing AP. In this manner, the cloud server 700 can supplement the missing AP and resume monitoring even for the missing AP by changing the frequency channel to capture packets. The cloud server 700 may also monitor the wireless LAN terminal instead of or together with the AP. The frequency channel used by the wireless LAN terminal is dynamically changed linked with a change of the frequency channel in the AP. Accordingly, the cloud server 700 may resume the monitoring of the wireless LAN terminal that can no longer be monitored due to the change of the frequency channel in the AP by using the same procedure as the procedure for resuming the monitoring of the missing AP.

Moreover, if the cloud server 700 is unable to detect the missing AP even after all frequency channels available to the missing AP are searched, it can determine that a failure has occurred in the missing AP.

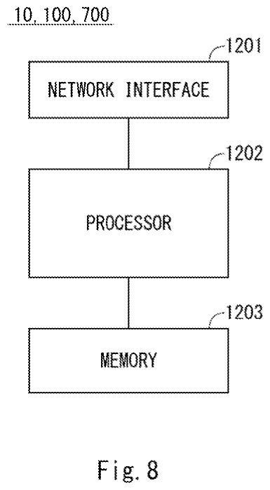

FIG. 8 is a block diagram showing a configuration example of the server apparatus 10, the wireless sensor 100, and the cloud server 700 (hereafter referred to as the server apparatus 10 and so on). With reference to FIG. 8, the server apparatus 10 and the like include a network interface 1201, a processor 1202, and a memory 1203. The network interface 1201 is used to communicate with network nodes (e.g., eNB, MME, P-GW). The network interface 1201 may include, for example, a network interface card (NIC) conforming to the IEEE 802.3 series. The eNB stands for evolved Node B, MME stands for Mobility Management Entity, and P-GW stands for Packet Data Network Gateway. The IEEE stands for Institute of Electrical and Electronics Engineers.

The processor 1202 reads and executes software (computer program) from the memory 1203 to perform processing of the server apparatus 10 and the like described using the flowchart in the above described example embodiments. The processor 1202 may be, for example, a microprocessor, an MPU, or a CPU. The processor 1202 may include a plurality of the processors.

The memory 1203 is composed of a combination of volatile and non-volatile memories. The memory 1203 may include a storage that is separate from the processor 1202. In this case, the processor 1202 may access the memory 1203 via an I/O (Input/Output) interface (not shown).

In the example of FIG. 8, the memory 1203 is used to store software modules. By reading these software modules from the memory 1203 and executing them, the processor 1202 can perform processing of the server apparatus 10 and the like described in the above example embodiments.

As explained using FIG. 8, each of the processors in the server apparatus 10 and the like in the above described example embodiments executes one or more programs including instructions for causing the computer perform the algorithm described with reference to the drawings.

In the above example, the program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (Read Only Memory), CD-R, CD-R/W, and semiconductor memories (such as Mask ROM, PROM (Programmable ROM), EPROM (Erasable PROM), flash ROM, RAM (Random Access Memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

The present disclosure is not limited to the above example embodiment and may be changed as appropriate without departing from the purport.

The present disclosure has been described above with reference to the example embodiments, but the present disclosure is not limited by the above. The configuration and details of the present disclosure may be modified in a variety of ways that those skilled in the art may understand within the scope of the disclosure.

The whole or part of the example embodiments disclosed above can be described as, but not limited to, the following supplementary notes.

(Supplementary note 1)

A server apparatus comprising:

a management unit configured to manage a list showing a first access point that can no longer be monitored among a plurality of access points to be monitored;

a communication unit configured to transmit a collection condition indicating frequency channels available to the first access point to a sensor apparatus and receiving monitoring data generated by the sensor apparatus from packets collected according to the collection condition; and

a monitoring unit configured to resume monitoring of the first access point when the monitoring data includes information specifying the first access point.

(Supplementary note 2)

The server apparatus according to Supplementary note 1, wherein

the communication unit is configured to transmit an extraction condition for generating the monitoring data to the sensor apparatus.

(Supplementary note 3)

The server apparatus according to Supplementary note 1 or 2, wherein

the information specifying the first access point includes at least one of address information about the first access point and information about received signal strength when the sensor apparatus receives the packets from the first access point.

(Supplementary note 4)

The server apparatus according to any one of Supplementary notes 1 to 3, wherein

the management unit is configured to add the first access point to the list when the management unit cannot obtain the information specifying the first access point for a predetermined period of time.

(Supplementary note 5)

The server apparatus according to any one of Supplementary notes 1 to 4, wherein

the monitoring unit is configured to determine that a failure has occurred in the first access point when the monitoring data does not include information specifying the first access point after the sensor apparatus measures all frequency channels available to the first access point.

(Supplementary note 6)

The server apparatus according to any one of Supplementary notes 1 to 5, wherein

the management unit is configured to remove the first access point from the list when the monitoring data includes the information specifying the first access point.

(Supplementary note 7)

A sensor apparatus comprising:

a communication unit configured to receive a collection condition indicating a frequency channel from a server apparatus;

a collection unit configured to collect packets transmitted from an access point according to the collection condition; and

an extraction unit configured to generate monitoring data that the server apparatus is to be notified of from the collected packets, wherein

the communication unit is configured to transmit the monitoring data to the server apparatus.

(Supplementary note 8)

The sensor apparatus according to Supplementary note 7, wherein

the communication unit is configured to receive an extraction condition for generating the monitoring data from the server apparatus.

(Supplementary note 9)

A visualization system comprising:

a sensor apparatus configured to collect packets transmitted from an access point according to a collection condition indicating a frequency channel; and

a server apparatus configured to manage a list indicating a first access point that can no longer be monitored among a plurality of access points to be monitored, transmit a collection condition indicating frequency channels available to the first access point to the sensor apparatus, receive monitoring data generated by the sensor apparatus from the packets collected according to the collection condition, and resume monitoring the first access point when the monitoring data includes information specifying the first access point.

(Supplementary note 10)

The visualization system according to Supplementary note 9, wherein

the server apparatus is configured to transmit an extraction condition for generating the monitoring data to the sensor apparatus.

(Supplementary note 11)

A monitoring method executed by a server apparatus comprising:

managing a list showing a first access point that can no longer be monitored among a plurality of access points to be monitored;

transmitting a collection condition indicating frequency channels available to the first access point to a sensor apparatus;

receiving monitoring data generated by the sensor apparatus from packets collected according to the collection condition; and

resuming monitoring of the first access point when the monitoring data includes information specifying the first access point.

(Supplementary note 12)

A collection method executed by a sensor apparatus comprising:

receiving a collection condition indicating a frequency channel from a server apparatus;

collecting packets transmitted from an access point according to the collection condition; and

generating monitoring data that the server apparatus is to be notified of from the collected packets, wherein

the monitoring data is transmitted to the server apparatus.

(Supplementary note 13)

A program for causing a computer to execute:

managing a list showing a first access point that can no longer be monitored among a plurality of access points to be monitored;

transmitting a collection condition indicating frequency channels available to the first access point to a sensor apparatus;

receiving monitoring data generated by the sensor apparatus from packets collected according to the collection condition; and

resuming monitoring of the first access point when the monitoring data includes information specifying the first access point.

(Supplementary note 14)

A program for causing a computer to execute:

receiving a collection condition indicating a frequency channel from a server apparatus;

collecting packets transmitted from an access point according to the collection condition; and

generating monitoring data that the server apparatus is to be notified of from the collected packets, wherein

the monitoring data is transmitted to the server apparatus.

This application claims priority on the basis of Japanese Patent Application No. 2020-114078, filed Jul. 1, 2020, the entire disclosure of which is incorporated herein by reference.

### REFERENCE SIGNS LIST

10 SERVER APPARATUS
11 MANAGEMENT UNIT
12 COMMUNICATION UNIT
13 MONITORING UNIT
100 WIRELESS SENSOR
101 WIRELESS SENSOR
102 WIRELESS SENSOR
111 COMMUNICATION UNIT
112 COLLECTION UNIT
113 EXTRACTION UNIT
200 AP
201 AP
202 AP
300 WIRELESS LAN TERMINAL
301 WIRELESS LAN TERMINAL
302 WIRELESS LAN TERMINAL
400 BASE STATION
500 CORE NETWORK
600 INTERNET
700 CLOUD SERVER
701 CONDITION DETERMINATION UNIT
702 MONITORING UNIT
703 COMMUNICATION UNIT
704 MANAGEMENT UNIT

What is claimed is:

1. A server apparatus comprising:
at least one memory storing instructions, and
at least one processor configured to execute the instructions to;
manage a list showing a first access point that can no longer be monitored among a plurality of access points to be monitored;
transmit a collection condition indicating frequency channels available to the first access point to a sensor apparatus and receive monitoring data generated by the sensor apparatus from packets collected according to the collection condition; and
resume monitoring of the first access point when the monitoring data includes information specifying the first access point.

2. The server apparatus according to claim 1, wherein
the at least one processor is further configured to execute the instructions to transmit an extraction condition for generating the monitoring data to the sensor apparatus.

3. The server apparatus according to claim 1, wherein
the information specifying the first access point includes at least one of address information about the first access point and information about received signal strength when the sensor apparatus receives the packets from the first access point.

4. The server apparatus according to claim 1, wherein
the at least one processor is further configured to execute the instructions to add the first access point to the list when the information specifying the first access point cannot be obtained for a predetermined period of time.

5. The server apparatus according to claim 1, wherein
the information specifying the first access point determine that a failure has occurred in the first access point when the monitoring data does not include information specifying the first access point after the sensor apparatus measures all frequency channels available to the first access point.

6. The server apparatus according to claim 1, wherein
the at least one processor is further configured to execute the instructions to remove the first access point from the list when the monitoring data includes the information specifying the first access point.

7. (canceled)

8. (canceled)

9. A visualization system comprising:
a sensor apparatus configured to collect packets transmitted from an access point according to a collection condition indicating a frequency channel; and
a server apparatus configured to manage a list indicating a first access point that can no longer be monitored among a plurality of access points to be monitored, transmit a collection condition indicating frequency channels available to the first access point to the sensor apparatus, receive monitoring data generated by the sensor apparatus from the packets collected according to the collection condition, and resume monitoring the first access point when the monitoring data includes information specifying the first access point.

10. The visualization system according to claim 9, wherein
the server apparatus is configured to transmit an extraction condition for generating the monitoring data to the sensor apparatus.

11. A monitoring method executed by a server apparatus comprising:
managing a list showing a first access point that can no longer be monitored among a plurality of access points to be monitored;
transmitting a collection condition indicating frequency channels available to the first access point to a sensor apparatus;
receiving monitoring data generated by the sensor apparatus from packets collected according to the collection condition; and
resuming monitoring of the first access point when the monitoring data includes information specifying the first access point.

12. (canceled)

13. (canceled)

14. (canceled)
